(19) United States
(12) Patent Application Publication
(10) Pub. No.: US 2021/0198435 A1
(43) Pub. Date: Jul. 1, 2021

(54) COMPOSITE MATERIAL DERIVED FROM LIGNOCELLULOSIC BIOMASS AND METHOD FOR PRODUCING THE SAME

(71) Applicant: NATIONAL UNIVERSITY CORPORATION KANAZAWA UNIVERSITY, Ishikawa (JP)

(72) Inventors: Shiori SUZUKI, Ishikawa (JP); Stephanie HERNANDEZ, Ishikawa (JP); Hibiki HIKIDA, Ishikawa (JP); Yosuke HAMANO, Ishikawa (JP); Kenji TAKAHASHI, Ishikawa (JP)

(73) Assignee: NATIONAL UNIVERSITY CORPORATION KANAZAWA UNIVERSITY, Ishikawa (JP)

(21) Appl. No.: 17/271,304

(22) PCT Filed: Aug. 28, 2019
(86) PCT No.: PCT/JP2019/033744

§ 371 Date: Feb. 25, 2021

(30) Foreign Application Priority Data
Aug. 28, 2018 (JP) 2018-159416

(51) Int. Cl. C08H 8/00; C08L 97/02

(52) U.S. Cl. CPC C08H 8/00; C08L 97/02

(57) ABSTRACT

It is an object of the present invention to obtain a novel composite material excellent in terms of flexibility and thermoformability from a lignocellulosic biomass as a raw material.

A composite material, in which some hydroxy groups of a lignocellulosic biomass are esterified, which is characterized in that
the esterified portion has short-chain acyl groups containing 2 to 4 carbon atoms and long-chain acyl groups containing 3 to 18 carbon atoms.

### TECHNICAL FIELD

The present invention relates to a composite material derived from a lignocellulosic biomass and a method for producing the same.

### BACKGROUND ART

Towards the realization of a low-carbon society, utilization of carbon-neutral resources has been strongly desired. In particular, a lignocellulosic biomass that does not compete with foods and is abundantly present in the nature has attracted attention. Lignocellulosic biomass, such as wood, is a polymeric composite material composed of cellulose, hemicellulose, and lignin that is a polycyclic aromatic polymer. These three components bind to one another via strong hydrogen bonds or the like, and thus have a beautiful, refined, and strong structure. It has been desired to develop a technique of obtaining a more useful material using this lignocellulosic biomass as a raw material.

In order to develop a technique of converting a lignocellulosic biomass to a useful material, there has been proposed the use of an ionic liquid that is a liquid-state organic salt at room temperature. For example, Patent Literature 1 discloses a method for producing a polysaccharide derivative, comprising performing a reaction in a mixture comprising a raw material containing polysaccharides, an ionic liquid for which the pKa of a conjugate acid of an anion in DMSO is 12 to 19 and which is capable of producing a carbene, and a chain or cyclic ester compound or an epoxy compound.

### CITATION LIST

### Patent Literature

Patent Literature 1: International Publication WO2016/068053

### SUMMARY OF INVENTION

### Technical Problem

According to the above-described Patent Literature 1, an ionic liquid, such as 1-ethyl-3-methylimidazolium acetate, which solubilizes a lignocellulosic biomass and also functions as a catalyst in a transesterification reaction, is utilized, and a polysaccharide derivative can be directly obtained from a lignocellulosic biomass used as a raw material, while maintaining a high degree of polymerization.

However, although the material for the polysaccharide derivative obtained by the above-described Patent Literature 1 has been excellent in terms of mechanical strength, there has been room for improvement in terms of flexibility and thermoformability. Hence, it is an object of the present invention to obtain a novel composite material excellent in terms of flexibility and thermoformability, using a lignocellulosic biomass as a raw material.

### Solution to Problem

In order to achieve the aforementioned object, the present inventors have conducted intensive studies. As a result, the inventors have found that a composite material excellent in terms of flexibility and thermoformability can be obtained, by esterification of some hydroxy groups of a lignocellulosic biomass with short- and long-chain acyl groups, thereby completing the present invention. Namely, the essentials of the present invention are as follows.

(1) A composite material, in which some hydroxy groups of a lignocellulosic biomass are esterified, wherein

the esterified portion has short-chain acyl groups containing 2 to 4 carbon atoms and long-chain acyl groups containing 3 to 18 carbon atoms.

(2) The composite material according to (1) above, wherein both the short-chain acyl groups and the long-chain acyl groups are alkanoyl groups.
(3) The composite material according to (1) or (2) above, wherein with regard to the molar ratio between the short-chain acyl groups and the long-chain acyl groups, the short-chain acyl groups: the long-chain acyl groups=7:1 to 1:3.
(4) The composite material according to any one of (1) to (3) above, wherein the substitution percentage to the short-chain acyl groups and the long-chain acyl groups is 75 mol % or more.
(5) A multi-component composite material formed by mixing the composite material according to any one of (1) to (4) above with another organic or inorganic material.
(6) A method for producing the composite material according to any one of (1) to (4) above, comprising:

a step of performing a reaction in a mixture comprising a biomass containing lignocellulose, an ionic liquid consisting of a cation not having hydroxy groups and a carboxylate anion, and an ester compound having long-chain acyl groups containing 3 to 18 carbon atoms,

a step of adding another ester compound having short-chain acyl groups containing 2 to 4 carbon atoms to the mixture, followed by performing a reaction, and

a step of adding the reaction solution to a poor solvent to perform precipitation of the composite material according to any one of (1) to (4) above.

(7) The method for producing the composite material according to (6) above, wherein the poor solvent is water.
(8) The method for producing the composite material according to (6) or (7) above, wherein a cation of the ionic liquid is based on an imidazolium cation.

The present description claims the priority of the present application based on Japanese Patent Application No. 2018-159416, which disclosure is incorporated herein.

### Advantageous Effects of Invention

According to the present invention, using a lignocellulosic biomass as a raw material, a composite material, in which three components, namely, a cellulose derivative, a hemicellulose derivative, and a lignin derivative are integrally become compatible or bind with one another, can be obtained. This composite material has the mechanical strength and rigidity of the cellulose derivative, the flexibility of the hemicellulose derivative, and the properties of the lignin derivative such as UV resistance, high rigidity, high heat insulation properties, and high sound insulation properties, with good balance. In addition, since this composite material has good thermoformability, it can be used in injection molding. Accordingly, the present composite material can be preferably used as a thermoplastic resin material in 3D printing technique and the like.

### BRIEF DESCRIPTION OF DRAWINGS

FIG. 1 is a graph showing the results obtained by measuring the materials of Example 1 and Comparative Examples 1 and 2, using a flow tester.

FIG. 2 is a stress-strain curve of the materials of Example 1 and Comparative Examples 2 and 4.

### DESCRIPTION OF EMBODIMENTS

The present invention will be described in detail below.

In the composite material of the present invention, some hydroxy groups of a lignocellulosic biomass are esterified. The esterified portion has short-chain acyl groups containing 2 to 4 carbon atoms and long-chain acyl groups containing 3 to 18 carbon atoms (provided that the number of carbon atoms contained in the long-chain acyl group is larger than the number of carbon atoms contained in the short-chain acyl group).

As a lignocellulosic biomass used herein, any material can be applied, as long as it is a material multiply comprising cellulose, hemicellulose and lignin. Examples of the material that can be utilized as a lignocellulosic biomass herein may include all types of wood-based materials such as plants, chips of softwoods such as cedar or hardwoods, thinned woody materials, construction waste materials, and mushroom waste beds. Materials of angiosperms, in which the main component of hemicellulose in a biomass raw material is glucurono xylan, are preferably used. As a specific example, a lignocellulosic biomass can be appropriately selected from among wood materials such as bagasse (sugarcane residue), kenaf, bamboo or eucalyptus, ginkgo, or a mixture of these two or more types, and can be used. Preferably, bagasse, eucalyptus or bamboo is used.

Examples of the short-chain acyl group containing 2 to 4 carbon atoms may include a saturated or unsaturated aliphatic acyl group containing 2 to 4 carbon atoms, and an aromatic acyl group. Herein, the number of carbon atoms contained in the short-chain acyl group means the number of carbon atoms that includes carbon atoms contained in a carbonyl group in the acyl group. The carbon chain may be either a linear chain or a branched chain. Specific examples may include an acetyl group, a propionyl group, a butyryl group, and an isobutyryl group. Among these, an acetyl group is preferable.

An example of the long-chain acyl group containing 3 to 18 carbon atoms may be a saturated or unsaturated, aliphatic or aromatic acyl group containing 3 to 18 carbon atoms. Herein, the number of carbon atoms contained in the long-chain acyl group means the number of carbon atoms that includes carbon atoms contained in a carbonyl group in the acyl group. The carbon chain may be either a linear chain or a branched chain. Specific examples may include saturated or unsaturated aliphatic acyl groups such as a propionyl group, a butyryl group, an isobutyryl group, a pentanoyl group, a hexanoyl group, an ethylhexanoyl group, a heptanoyl group, a decanoyl group, a stearoyl group or an oleoyl group, and aromatic acyl groups such as a benzoyl group, a toluoyl group or a naphthoyl group. Among these, an acyl group containing 8 to 18 carbon atoms, such as a decanoyl group, is preferable.

In particular, both the short-chain acyl group and the long-chain acyl group are preferably alkanoyl groups. In addition, a difference between the number of carbon atoms of the short-chain acyl group and the number of carbon atoms of the long-chain acyl group is preferably 3 or more, and more preferably 4 or more. A preferred example, in which a difference in the number of carbon atoms is 3 or more, is a case where the short-chain acyl group is an acetyl group while the long-chain acyl group is a decanoyl group.

The molar ratio between the short-chain acyl groups and the long-chain acyl groups in the composite material is not particularly limited. If the ratio of the long-chain acyl groups is too large, it is not proper because the composite material becomes a waxy material. In contrast, if the ratio of the short-chain acyl groups is too large, the crystal structure in the composite material is not destroyed and remains, so that the molding temperature of the material becomes high, which results in deterioration of thermoformability. Accordingly, considering these balances, the molar ratio between the short-chain acyl groups and the long-chain acyl groups in the composite material is determined, as appropriate. Specifically, the molar ratio between the short-chain acyl groups and the long-chain acyl groups is preferably set to be within the range of 7:1 to 1:3. The molar ratio between the short-chain acyl groups and the long-chain acyl groups is more preferably within the range of 6:1 and 2:3. The molar ratio between the short-chain acyl groups and the long-chain acyl groups can be measured, as appropriate, by applying a method such as ¹H NMR analysis.

If the ratio of unreacted hydroxy groups in the composite material is too large, the effect of improving thermoformability cannot be obtained. Thus, such unreacted hydroxy groups are desirably in a small amount. Specifically, although the amount of unreacted hydroxy groups is not univocally determined because it is different depending on the types of the short-chain and long-chain acyl group, etc., the substitution percentage with the short-chain acyl groups and the long-chain acyl groups is preferably 75 mol % or more. That is, the molar ratio of the unreacted hydroxy groups to a total of the esterified hydroxy groups and the unreacted hydroxy groups is preferably 0% to 25%, and more preferably 0% to 5%. The substitution percentage with the short-chain acyl groups and the long-chain acyl groups and the amount of the unreacted hydroxy groups can be measured, as appropriate, by applying a method such as ³¹P NMR analysis.

In the composite material of the present invention, some hydroxy groups are esterified with two types of acyl groups, namely, short-chain acyl groups and long-chain acyl groups. However, as necessary, some other hydroxy groups that are not esterified with such short-chain acyl groups or long-chain acyl groups may be further substituted with other groups. For example, hydroxy groups other than the hydroxy groups esterified with the short-chain acyl groups or the long-chain acyl groups can be further esterified with other third acyl groups. The molar ratio of such hydroxy groups substituted with groups other than the short-chain acyl groups or the long-chain acyl groups is preferably less than 40% in all of the hydroxy groups (including substituted hydroxy groups such as esterified hydroxy groups).

The composite material of the present invention has a structure in which three components, namely, cellulose ester, hemicellulose ester and lignin ester, are compatible with one another. The content of each component is not particularly limited, and for example, the content of the lignin ester is preferably 1% to 30% by mass, and more preferably 1% to 10% by mass, based on the total mass of the composite material. In addition, the content of the hemicellulose ester is 1% to 30% by mass, and more preferably 1% to 10% by mass, based on the total mass of the composite material.

Since the aforementioned composite material has short-chain acyl groups and long-chain acyl groups, it becomes a thermoplastic resin that is excellent in thermoformability. Moreover, the aforementioned composite material has mechanical strength and rigidity derived from the cellulose ester, flexibility derived from the hemicellulose ester, and UV resistance, high rigidity, high heat insulation properties, and high sound insulation properties derived from the lignin ester, and thus, the composite material can be applied for various intended uses. The composite material of the present invention can be used in injection molding, and can also be reeled up in a thread form according to melt-spinning. Accordingly, the present composite material can be utilized as a thermoplastic resin in 3D printing.

Moreover, the composite material of the present invention can also be used as a multi-component composite material that is mixed with another organic or inorganic material. Specifically, inorganic fibers such as carbon fibers or glass fibers are mixed with the present composite material, so that carbon fiber or glass fiber reinforced plastics can be prepared. Furthermore, the present composite material may also be mixed with organic fibers such as cellulose fibers or lignocellulose fibers. In addition, the composite material may be used as a polymer alloy with polyolefin such as polypropylene, or with an existing plastic material such as polylactic acid or polycarbonate. The lignin component contained in the composite material is an aromatic polymer, and this aromatic polymer has a chemical affinity with the surface of carbon fibers or an existing plastic material containing an aromatic ring, such as a polycarbonate. Utilizing these properties, the composite material of the present invention can be preferably used as a resin material for producing carbon fiber reinforced plastics. Further, acyl groups such as alkanoyl groups contained in the composite material of the present invention exhibit a favorable affinity also with hydrocarbon plastics such as polyolefin according to a hydrophobic interaction that functions between molecules (mainly, Van der Waals force). Further, since unreacted hydroxy groups generate hydrogen bonds with the surfaces of cellulose fibers, lignocellulose fibers, and polylactic acids, the present composite material can be used as a multi-component composite material excellent in compatibility, which can be applied for various intended uses.

Next, a method for producing the above-described composite material will be described.

The method for producing the composite material of the present invention comprises: a step of performing a reaction in a mixture comprising a lignocellulosic biomass, an ionic liquid consisting of a cation not having hydroxy groups and a carboxylate anion, and an ester compound having long-chain acyl groups containing 3 to 18 carbon atoms, a step of adding an ester compound having short-chain acyl groups containing 2 to 4 carbon atoms to the mixture, followed by performing a reaction, and a step of adding the reaction solution to a poor solvent to perform precipitation.

The lignocellulosic biomass used as a raw material is as described above. It is to be noted that the lignocellulosic biomass as a raw material can be subjected to various pre-treatments such as crushing and drying, as necessary, before being subjected to the reactions.

The ionic liquid used in the present invention is composed of a cation not having hydroxyl groups and a carboxylate anion (RCOO⁻: R represents a linear or branched alkyl group containing 1 to 3 carbon atoms, etc.). Such an ionic liquid functions as an effective organocatalyst in a derivatizing reaction for a lignocellulosic biomass in the present invention. Besides, as in the case of the following choline acetic acid, if a cation has a hydroxyl group, the ionic liquid itself becomes a reactant, and a biomass derivative of interest (composite material) cannot be inadequately obtained.

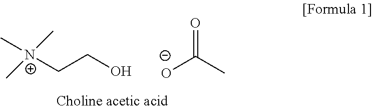

In particular, as a cation of the ionic liquid, an imidazolium salt having a cation represented by the following formula (1) (imidazolium-based ionic liquid) is preferable, but is not limited thereto.

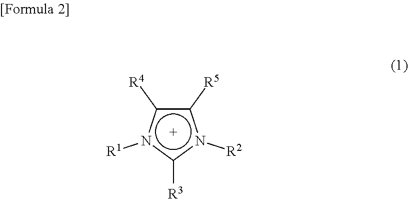

wherein R¹ and R² each independently represent an alkyl group, an alkenyl group, an alkoxyalkyl group, or a substituted or unsubstituted phenyl group, and R³ to R⁵ each independently represent hydrogen, an alkenyl group, an alkoxyalkyl group, or a substituted or unsubstituted phenyl group.

Examples of the above-described alkyl group may include linear or branched alkyl groups containing 1 to 20 carbon atoms, such as a methyl group, an ethyl group, an n-propyl group, an isopropyl group, a butyl group, a hexyl group, or an octyl group. To the termini of these alkyl groups, a sulfo group may bind. Examples of the alkenyl group may include linear or branched alkenyl groups containing 1 to 20 carbon atoms, such as a vinyl group, a 1-propenyl group, a 2-propenyl group, a 1-butenyl group, a 2-butenyl group, a 1-pentenyl group, a 2-pentenyl group, a 1-hexenyl group, a 2-hexenyl group, or 1-octenyl group. Examples of the alkoxyalkyl group may include linear or branched alkoxyalkyl groups containing 2 to 20 carbon atoms, such as a methoxymethyl group, an ethoxymethyl group, a 1-methoxyethyl group, a 2-methoxyethyl group, a 1-ethoxyethyl group, or a 2-ethoxyethyl group. Moreover, examples of the substituted or unsubstituted phenyl group may include phenyl groups optionally substituted with one or two groups selected from among a hydroxy group, a halogen atom, a lower alkoxy group, a lower alkenyl group, a methylsulfonyloxy group, a substituted or unsubstituted lower alkyl group, a substituted or unsubstituted amino group, a substituted or unsubstituted phenyl group, a substituted or unsubstituted phenoxy group, and a substituted or unsubstituted pyridyl group.

Examples of the ionic liquid preferably used in the present invention may include the following compounds, but are not limited thereto.

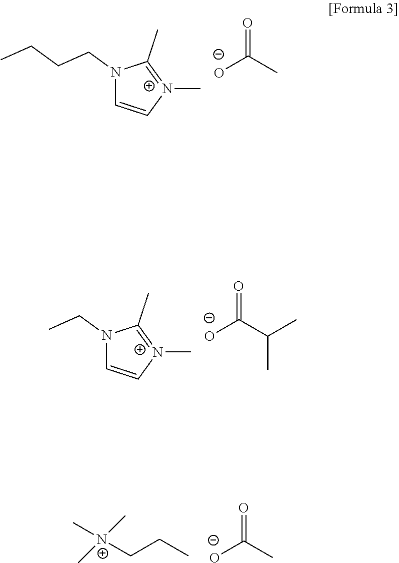

The above-described ionic liquid serves as a solvent for the biomass raw material, and it destroys the layer structure consisting of cellulose, hemicellulose, and lignin contained in the biomass raw material, and alleviates physical interactions among individual components. At the same time, a carbene generated from an imidazolium cation or a carboxylate anion functions as a catalyst, so that derivatization of each of the cellulose component, the hemicellulose component and the lignin component that constitute the biomass raw material progresses. For example, in an ionic liquid of 1-ethyl-3-methylimidazolium acetate (EmimOAc), a biomass, vinyl decanoate serving as an ester compound having long-chain acyl groups, and isopropenyl acetate serving as an ester compound having short-chain acyl groups are allowed to react with one another, so that the ionic liquid functions as a catalyst, as mentioned above, and an acetylated and decanoylated biomass (composite material) is generated as a result of transesterification reactions. In a lignin molecule, hydroxy groups bound to aromatic carbons and hydroxy groups bound to aliphatic carbons are present. According to the present invention, both of the hydroxy groups can be substituted.

The concentration of the biomass raw material in the ionic liquid serving as a solvent is different, depending on the type or molecular weight of the biomass, and is not particularly limited. The weight of the ionic liquid is preferably set to be two times or more of the weight of the biomass raw material, and in particular, the concentration of the biomass raw material in the ionic liquid is preferably set to be 3% by weight to 6% by weight.

Alternatively, the ionic liquid can be utilized in a co-solvent system with an organic solvent. In this case as well, the weight of the ionic liquid is preferably set to be two times or more of the weight of the biomass raw material. The amount of the ionic liquid can be reduced in the range of these conditions, and the rest is substituted with an organic solvent, so that the production costs of individual derivatives can be suppressed.

The organic solvent used as a co-solvent can be selected, as appropriate, from among various organic solvents that do not react with the ionic liquid, while taking into consideration solubility to a biomass derivative (composite material) to be generated, etc. Specific examples of the organic solvent used herein may include acetonitrile, tetrahydrofuran (THF), dimethylformamide (DMF), dimethylacetamide (DMAc), dimethyl sulfoxide (DMSO), 1,3-dioxolane, and 1,4-dioxane. Among these, tetrahydrofuran (THF), dimethyl sulfoxide (DMSO), 1,3-dioxolane and the like are preferably used, although the organic solvents used herein are not limited thereto. Chloroform is usually not suitable as an organic solvent herein in many cases because it can react with some ionic liquids such as 1-ethyl-3-methylimidazolium acetate (EmimOAc). However, chloroform is not excluded from the scope of the present invention.

As an ester compound to be reacted, a compound corresponding to short-chain acyl groups and long-chain acyl groups to be introduced can be appropriately selected and used. Specific examples of the ester compound may include compounds selected from isopropenyl carboxylates such as isopropenyl acetate, and carboxylic acid esters such as vinyl carboxylate or methyl carboxylate. Originally, carboxylic acid esters have been known as an extremely stable chemical substances, differing from carboxylic acid anhydride, etc. Accordingly, in order to occur a transesterification reaction, it has been essential to use an additional catalyst. As such, in a general esterification reaction, a highly activated carbonyl compound having corrosive properties (e.g., carboxylic acid anhydride or carboxylic acid halide (chloride, bromide, etc.)) has been used to promote the esterification reaction. In the present invention, since the ionic liquid serving as not only a solvent but also a catalyst, derivatization can be carried out via a transesterification reaction without adding a catalyst, separately.

The amount of such an ester compound is different depending on the type of the biomass raw material, etc. For example, an ester compound having short-chain acyl groups and an ester compound having long-chain acyl groups are preferably allowed to react with a biomass raw material, in a total amount of 10 to 30 equivalents to 1 equivalent of hydroxy groups present in the biomass raw material. Moreover, it is preferable to add to a biomass raw material, an ester compound having short-chain acyl groups in an excessively larger amount than that of an ester compound having long-chain acyl groups. Specifically, it is preferable to add to a biomass raw material, 10 to 29 equivalents of the ester compound having short-chain acyl groups and 0.1 to 1 equivalent of the ester compound having long-chain acyl groups, with respect to 1 equivalent of hydroxy groups present in the biomass raw material, but the amounts of these ester compounds are not limited thereto.

Furthermore, the reaction conditions are not particularly limited, as long as they are conditions under which the ionic liquid functions as a catalyst and the reaction progresses. Such reaction conditions can be determined, as appropriate, depending on the type of the biomass raw material, etc. For instance, under a nitrogen or argon atmosphere, a mixture of a lignocellulosic biomass, an ionic liquid, and an ester compound is stirred at a temperature of 10° C. to 80° C. for 0.5 hours to 48 hours, so that the reaction can be carried out. The reaction time depends on the temperature. For example, when the reaction is carried out at 50° C., the reaction time is preferably set to be 2 hours or more, and when the reaction is carried out at 10° C., the reaction time is preferably set to be a long period of time.

The ester compound having short-chain acyl groups and the ester compound having long-chain acyl groups may be added simultaneously to a mixture of a lignocellulosic biomass and an ionic liquid. However, preferably, the ester compound having long-chain acyl groups is first added to a mixture of a biomass containing lignocellulose and an ionic liquid, followed by performing a reaction, and thereafter, the ester compound having short-chain acyl groups is subsequently added to the reaction mixture, followed by performing a reaction. By allowing the ester compound having short-chain acyl groups to react with the unreacted hydroxy groups in the reaction mixture after the reaction of the ester compound having long-chain acyl groups, both the long-chain acyl groups and the short-chain acyl groups can be easily introduced into the mixture with a targeted ratio for thermal workability.

After termination of the reaction, as necessary, insoluble components and impurities are removed from the reaction solution by a method such as filtration under reduced pressure, and are appropriately concentrated. Thereafter, the reaction solution is added to a poor solvent, and precipitation is then carried out to obtain a composite material of interest. The generated composite material is separated by filtration or the like, and is then dried, so that it can be applied as a thermoplastic resin material for various intended uses. The poor solvent used in the precipitation is not particularly limited, and water, hexane, alcohols such as methanol, and the like can be used. The poor solvent is preferably water.

Besides, the used ionic liquid can be recovered by passing the solution obtained during each process, such as, for example, the solution after separating the generated composite material, through a cation exchange resin or the like. The recovered ionic liquid can be mixed with a biomass as a raw material again and utilized as a solvent and/or a catalyst for the reaction of the present invention.

### EXAMPLES

The present invention will be described below more specifically by way of Examples and Comparative Examples, provided that the technical scope of the present invention be not limited thereto.

### 1. Production of Composite Material

### Example 1

A residue (bagasse) of a sugarcane juice was used as a lignocellulose biomass sample. The bagasse was pulverized to grains with a diameter of 250 μm or less, and was then subjected to a delipidation treatment. The bagasse (6 g, 6% by weight/EmimOAc) was added to 1-ethyl-3-methylimidazolium acetate (EmimOAc)/dimethyl sulfoxide (DMSO) (volume ratio: 1:1.6), and the obtained mixture was then stirred under an Ar atmosphere at 110° C. for 16 hours, so that the sample was completely dissolved. The obtained homogeneous solution was cooled to 80° C., and thereafter, vinyl decanoate (4.2 mL, 0.25 molar equivalents to 1 equivalent of hydroxy groups present in the bagasse) was added as an ester compound having long-chain acyl groups to the solution. The mixed solution was stirred at 80° C. for 30 minutes. Subsequently, isopropenyl acetate (200 mL, 25 equivalents with respect to 1 equivalent of hydroxy groups present in the bagasse) was added as an ester compound having short-chain acyl groups to the reaction solution, and the resultant mixture was stirred at 80° C. for 30 minutes. After termination of the reaction, the obtained black homogeneous solution was added dropwise to acetone (1.2 L), and the resultant mixture was then stirred at room temperature for 1 hour. Thereafter, insoluble components were removed by filtration under reduced pressure, and the filtrate was then concentrated, followed by precipitation into distilled water (6 L), to obtain a bagasse derivative of interest (a composite material, Bagasse AcDe). The reaction formula is shown below.

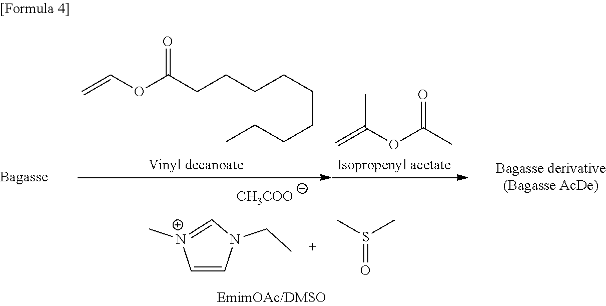

### Examples 2 and 3

A composite material was produced by performing esterification in the same manner as that of the above-described Example 1, with the exception that bamboo (Example 2) or eucalyptus (Example 3) was used as a lignocellulosic biomass (a raw material) instead of bagasse.

### Example 4

A composite material was produced in the same manner as that of the above-described Example 1, with the exceptions that the amount of isopropenyl acetate added was changed, and thus, the ratio of unreacted hydroxy groups, the short-chain acyl groups, and the long-chain acyl groups were changed.

### Examples 5 and 6

A composite material was produced in the same manner as that of the above-described Example 1, with the exceptions that the amount of vinyl decanoate added was changed, and thus, the ratio of unreacted hydroxy groups, the short-chain acyl groups, and the long-chain acyl groups were changed.

### Examples 7 to 9

A composite material was produced in the same manner as that of the above-described Example 1, with the exception that vinyl propionate (Example 7), vinyl butyrate (Example 8) or vinyl pivalate (Example 9) was added as an ester compound having short-chain acyl groups, instead of isopropenyl acetate.

### Example 10

A composite material was produced in the same manner as that of the above-described Example 1, with the exception that vinyl stearate (Example 10) was added as an ester compound having long-chain acyl groups, instead of vinyl decanoate.

### Comparative Example 1

6 g of Bagasse, which had been pulverized to powders with a grain diameter of 250 μm or less, was weighted in a 1 L Schlenk flask, and thereafter, 100 g of 1-ethyl-3-methylimidazolium and 150 mL of dimethyl sulfoxide were added thereto. The obtained mixture was stirred under an Ar atmosphere at 110° C. for 16 hours, so that the sample was completely dissolved. The obtained homogeneous solution was cooled to 80° C., and a small amount of vinyl decanoate was then added to the solution, followed by stirring the mixture at 80° C. for 30 minutes. Subsequently, an excessive amount of isopropenyl acetate was added to the reaction mixture, and the obtained mixture was then stirred at 80° C. for 30 minutes. After completion of the reaction, the reaction solution was added to an excessive amount of methanol for precipitation, and the precipitate was then filtrated and washed, so that an esterified polysaccharide having long-chain acyl groups and short-chain acyl groups (cellulose ester+hemicellulose ester, Polysaccharide AcDe) was recovered as powders. At this time, the lignin component was separated as a methanol filtrate.

### Comparative Example 2

An esterified cellulose having long-chain acyl groups and short-chain acyl groups (cellulose AcDe) was produced in the same manner as that of the above-described Comparative Example 1, with the exceptions that a cellulose pulp containing neither lignin nor hemicellulose was used as a raw material, and that a pulverization treatment was not carried out.

### Comparative Examples 3 to 6

The following materials were prepared for Comparative Examples 3 to 6.

Comparative Example 3: Cellulose acetate butyrate (a commercially available product)
Comparative Example 4: Polypropylene (a commercially available product)
Comparative Example 5: Nylon-6 (trademark, a commercially available product)
Comparative Example 6: ABS resin (a commercially available product)
2. Evaluation of thermal fluidity

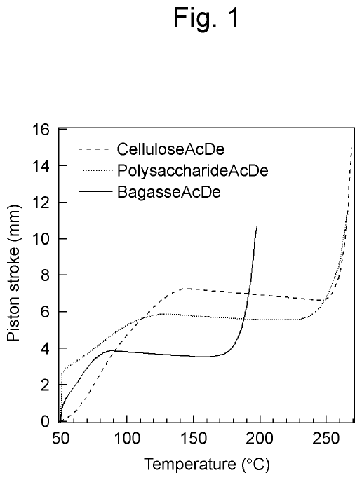

The composite material (Bagasse AcDe) of Example 1, the esterified polysaccharide material (Polysaccharide AcDe) of Comparative Example 1, and the esterified cellulose material (Cellulose AcDe) of Comparative Example 2 were evaluated in terms of thermal fluidity. Specifically, the thermal fluidity (softening temperature T_{soften}/melting initiation temperature T_{flow}/offset temperature T_{offset}) of each sample was evaluated in accordance with JIS K7210 (ISO1133), using a constant test force extrusion-type flow tester (manufactured by Shimadzu Corporation; brand name: CFT-500EX). The measurement initiation temperature was set at 50° C., the test pressure was set at 0.49 MPa, the die hole diameter was set at 1 mm, and the die length was set at 10 mm. The temperature at a time point at which a piston moved 5 mm from initiation of the melting of the sample was defined as an offset temperature. The measurement results are shown in FIG. 1.

As shown in FIG. 1, thermal-flowing of all of the resins of Examples 1 and Comparative Examples 1 and 2 was confirmed due to the appropriate substitutions with long-chain acyl groups and short-chain acyl groups. The offset temperature of Comparative Example 2 (Cellulose AcDe) was 266° C., whereas the offset temperature of Comparative Example 1 (Polysaccharide AcDe) consisting of cellulose ester/hemicellulose ester was 264° C. Both Comparative Examples 1 and 2 were solid and fragile molded products. Moreover, the offset temperature of the composite material (Bagasse AcDe) containing lignin ester in addition to the esterified polysaccharide like Comparative Example 1, was 194° C., and it was suggested that this composite material was excellent in thermal workability and also rich in flexibility. The offset temperature of the composite material of Example 1 decreased by 60° C. or more than those of Comparative Examples 1 and 2, and lignin ester was suggested to function as a plasticizer.

### 3. Tensile Test

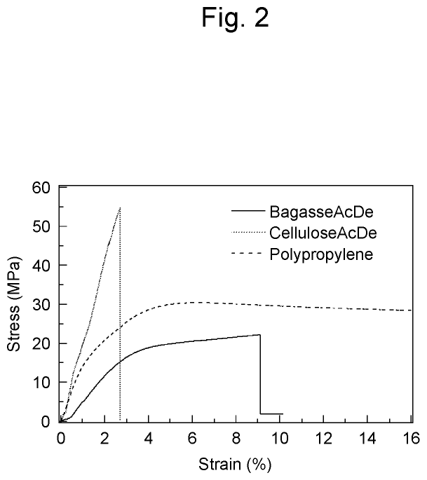

Individual materials obtained as Example 1 and Comparative Examples 2 and 4 were subjected to injection molding prior to a tensile test as described below. Using a kneading machine (manufactured by Xplore Instruments; brand name: Xplore MC5), individual materials were kneaded. During the kneading operation, the temperature of the kneading chamber of the kneading machine was set at 170° C., and the number of rotations was set at 60 rpm. Each material was put into a supply port of the kneading machine, and was then kneaded for 10 minutes. Using an injection molding machine (manufactured by Imoto Machinery Co., Ltd.; brand name: IMC-5705), a dumbbell-type test piece was produced from the above-described kneaded product in accordance with JIS K7161. Using a universal testing machine (manufactured by Shimadzu Corporation; brand name: AG-5kN Xplus), a tensile test was carried out on the test piece. The tension speed was set at 0.5 mm/min. The results are shown in FIG. 2.

From the results shown in FIG. 2, it was found that the material (Cellulose AcDe) of Comparative Example 2 had a strong strength, but that this material was broken by deformation of 2% to 3% and thus, was insufficient in flexibility or elongation. In contrast, the composite material of Example 1 had elongation that was approximately 3 times of the material of Comparative Example 2, and thus, the material was suggested to have flexibility. Moreover, the composite material of Example 1 had comparable tensile strength with that of the material (polypropylene) of Comparative Example 4.

4. Other measurements

Individual materials of Example 1 to 10 and Comparative Examples 1 to 3 were measured by ¹H NMR, in terms of the ratio between long-chain acyl groups and short-chain acyl groups.

In addition, with regard to individual materials of Example 1 to 10 and Comparative Examples 1 to 3, the amount of unreacted hydroxy groups was estimated by ³¹P NMR analysis (the method described in S. Suzuki et al., RSC Adv. 2018, 8, 21768-21776).

Furthermore, with regard to individual materials of Example 1 to 10 and Comparative Examples 1 and 2, the surface and flexibility of each molded product after the measurement using a flow tester were subjected to sensory evaluation. Further, the glass transition point (Tg) was determined by differential scanning calorimetry (DSC). The measurement results are summarized in the following table. In the following table, the substitution percentage to long-chain acyl groups and short-chain acyl groups of Example 1 is identical to that of Example 4. Note that the amount of unreacted hydroxy groups of Example 4 was larger than that of Example 1, and both the substitution percentage to long-chain acyl groups and the substitution percentage to short-chain acyl groups were slightly lower in Example 4 than those in Example 1.

TABLE 1

| | | | Substitution | | | | | | | |
|---|---|---|---|---|---|---|---|---|---|---|
| | | | percentage (mol %) | | | Molding | | | | |
| | | Synthesized | Long | Short | Hydroxyl | temperature (° C.) | | | Molded product ^{b} | |
| | | product ^{a} | chain | chain | group | T_{g} | T_{flow} | T_{offset} | Surface | Flexibility |
| Example | 1 | BagasseAcDe | 22 | 76 | 1.4 | 94 | 160 | 194 | ∘ | ∘ |
| | 2 | BambooAcDe | 23 | 74 | 3.2 | 95 | 163 | 191 | ∘ | ∘ |
| | 3 | EucalyptusAcDe | 22 | 74 | 3.9 | 94 | 160 | 181 | ∘ | ∘ |
| | 4 | BagasseAcDe | 22 | 76 | 2.3 | 94 | 154 | 186 | Δ | ∘ |
| | 5 | BagasseAcDe | 46 | 52 | 2.7 | 91 | 138 | 166 | ∘ | ∘ |
| | 6 | BagasseAcDe | 58 | 39 | 3.3 | 95 | 68 | 75 | ∘ | ∘ |
| | 7 | BaggasePrDe | 10 | 88 | 1.2 | 67 | 90 | 115 | ∘ | ∘ |
| | 8 | BagasseBuDe | 15 | 83 | 1.7 | 65 | 65 | 70 | ∘ | ∘ |
| | 9 | BagassePiDe | 15 | 83 | 3.1 | 63 | 70 | 97 | ∘ | ∘ |
| | 10 | BagasseAcSt | 23 | 75 | 1.9 | 93 | 142 | 166 | ∘ | Δ |
| Comparative | 1 | PolysaccharideAcDe | 24 | 76 | 0.6 | 100 | 219 | 264 | x | x |
| Example | 2 | CelluloseAcDe | 12 | 87 | 0.4 | 104 | 247 | 266 | Δ | x |
| | 3 | CelluloseAcBu | 24 | 69 | 7 | | 234 | 245 | | |
| | 4 | Polypropylene | | | | | 180 | 184 | | |
| | 5 | Nylon-6 | | | | | 224 | 230 | | |
| | 6 | ABS | | | | | 163 | 208 | | |

^{a} Bagasse XY (X: short-chain acyl group, Y: long chain acyl group)
^{b} Sensory evaluation of surface/flexibility of molded product after measurement with flow tester
(Surface) ∘: smooth; Δ: a few unevenness; x: rough
(Flexibility) ∘: can be reeled up; Δ: flexible, but fragile; x: rigid (break without bending)

As shown in the above table, it was found that the composite materials of Examples 1 to 10 having short-chain acyl groups containing 2 to 4 carbon atoms and long-chain acyl groups containing 8 to 16 carbon atoms, had a low offset temperature T_{offset}, compared with that of a polysaccharide ester (Comparative Example 1) or cellulose esters (Comparative Examples 2 and 3), and were excellent in terms of thermal workability. Moreover, in the case of the composite materials of Example 1 to 10, only one glass transition point was observed, and thus, it was suggested that individual components derived from cellulose, hemicellulose, and lignin were integrally compatible with one another.

All the publication, patent, and patent application cited herein are also herein incorporated as-are by reference.

1. A composite material, comprising a lignocellulosic biomass in which some hydroxy groups of the lignocellulosic biomass are esterified, wherein
the esterified portion has short-chain acyl groups containing 2 to 4 carbon atoms and long-chain acyl groups containing 3 to 18 carbon atoms.

2. The composite material according to claim 1, wherein both the short-chain acyl groups and the long-chain acyl groups are alkanoyl groups.

3. The composite material according to claim 1, wherein the molar ratio between the short-chain acyl groups and the long-chain acyl groups is from 7:1 to 1:3.

4. The composite material according to claim 1, wherein the substitution percentage of the short-chain acyl groups and the long-chain acyl groups is 75 mol % or more.

5. A multi-component composite material formed by mixing the composite material according to claim 1 with another organic or inorganic material.

6. A method for producing the composite material according to claim 1, comprising:
a) performing a reaction in a mixture comprising a biomass containing lignocellulose, an ionic liquid consisting of a cation not having hydroxy groups and a carboxylate anion, and an ester compound having long-chain acyl groups containing 3 to 18 carbon atoms,
b) adding another ester compound having short-chain acyl groups containing 2 to 4 carbon atoms to the mixture, followed by performing a reaction, and
c) adding the reaction solution resulting from step b) to a poor solvent to perform precipitation of the composite material according to claim 1.

7. The method for producing the composite material according to claim 6, wherein the poor solvent is water.

8. The method for producing the composite material according to claim 6, wherein a cation of the ionic liquid is based on an imidazolium cation.
